(19) United States
(12) Patent Application Publication
(10) Pub. No.: US 2009/0210171 A1
(43) Pub. Date: Aug. 20, 2009

(54) MONITORING DEVICE AND MONITORING METHOD FOR A SENSOR, AND SENSOR

(76) Inventor: Chengxuan Fu, Untergruppenbach (DE)

Correspondence Address: KENYON & KENYON LLP, ONE BROADWAY, NEW YORK, NY, 10004, US

(21) Appl. No.: 12/277,648

(22) Filed: Nov. 25, 2008

(30) Foreign Application Priority Data
Feb. 18, 2008 (DE) 10 2008 009 652.0

(51) Int. Cl. G06F 11/07

(52) U.S. Cl. 702/35; 702/188

(57) ABSTRACT

A monitoring device for a sensor of a motor vehicle, in particular a fuel cell motor vehicle, includes: a first sensor monitoring module for monitoring an operation of the sensor for faults; a second sensor monitoring module for monitoring the operation of the sensor for faults; a third sensor monitoring module for monitoring an operation of the second sensor monitoring module; a first data processing unit, which includes the first sensor monitoring module and is able to be coupled to the sensor; a second data processing unit, which is coupled to the first data processing unit, the second data processing unit being arranged such that a fault response signal is able to be output when a faulty operation of the sensor is detected.

### CROSS-REFERENCE TO RELATED APPLICATIONS

The present application claims priority to Application No. 10 2008 009 652.0, filed in the Federal Republic of Germany on Feb. 18, 2008, which is expressly incorporated herein in its entirety by reference thereto.

### FIELD OF THE INVENTION

The present invention relates to a monitoring device for monitoring a sensor, in particular a motor vehicle sensor, a method for monitoring a sensor, and to a sensor having a monitoring device.

### BACKGROUND INFORMATION

In vehicles having electronic throttle control systems (ETC), for example, a 3-level concept should be implemented in engine control devices. The core idea of the 3-level concept consists of mutual monitoring between a function computer and a separate monitoring module (watchdog). The function computer and the monitoring module communicate with one another via a query/answer communication and have separate switch-off paths via which corresponding power output stages are able to be switched off in the event of a malfunction, thereby ensuring the safety of the vehicle.

A first level (level 1) denotes an actual function software that is required for the operation of the engine. The first level is implemented on the function computer. In a second level (level 2), whose functions are likewise implemented on the function computer, a permitted value, e.g., a permitted torque, is compared to an actual value of the engine such as an actual engine torque, with the aid of an engine model that is simplified in comparison with the function software. This level is implemented in a hardware area safeguarded by a third level (level 3). Among the components of the third level are, for instance, an instruction test, a program sequence control, an A/D converter test as well as cyclical or complete memory tests.

In current electronic throttle control systems, the entire function and monitoring software is located in a control device. These are described in DE 44 38 714, for instance. In comparison with a 2-computer concept, which is typically used for ABS/ESP systems, the 3-level concept is more cost-effective.

DE 103 31 872 describes a method for monitoring a system having networked control devices is known, each of the control devices having at least one computer element and each implementing control processes as well as monitoring processes that are relevant to the monitoring. The control devices communicate with each other via a bus system. Furthermore, a method is described in which a communications component of a software frame spanning the control devices reads in fault response requests and functional variables of other control devices via the bus system, makes them available to the modules and components of the software frame, and outputs them again to other control devices via the bus system. However, this distribution of the control components to the control devices requires a high degree of effort, so that only a slow response time to a detected faulty operation is possible.

### SUMMARY

Example embodiments of the present invention provide an improved, in particular, more cost-effective and at the same time rapid possibility for the reliable output of a fault response signal if a faulty operation of a sensor has been detected.

Example embodiments of the present invention provide a monitoring device for monitoring a sensor, the monitoring device having the following features: a first and a second sensor monitoring module to monitor an operation of the sensor with regard to faults, as well as a third sensor monitoring module to monitor an operation of the second sensor monitoring module. Furthermore, the monitoring device includes a first data processing unit, which has the first sensor monitoring module and is able to be coupled or connected to the sensor, and a second data processing unit, which is coupled or connected to the first data processing unit, the second data processing unit being arranged such that a fault response signal is able to be output if a faulty operation of the sensor is detected.

The second data processing unit may have a higher performance capacity than the first data processing unit. Furthermore, the first and/or the second data processing unit may be coupled to the sensor via a signal bus.

The second sensor monitoring module is preferably designed as redundant sensor monitoring module, which ensures correct monitoring of the sensor with the aid of an additional provision of identical, functionally similar or comparable resources. The sensor monitoring modules may be in separate locations, which minimizes the risk that they are jointly affected by a fault. Furthermore, the sensor monitoring modules may have a different arrangement/configuration to prevent that a systematic fault causes a malfunction of the redundant sensor monitoring modules. This may also be applied to the third sensor monitoring module.

Currently an increasing number of bus-enabled sensors having corresponding interfaces is used, and at the same time a concept of distributed monitoring components is implemented to an increasing extent as well. Thus, it is exploited that these systems frequently use individual monitoring or general data processing components that are configured for very high performance (as far as processing rate and/or memory capacity, for example, are concerned) and thus provide a certain numerical spare capacity in such a monitoring system for a sensor. Such high-performance computing units may be used as a second data processing unit, which is able to determine and output the fault response signal on the basis of a detected faulty operation.

In most cases, to provide and preferably also output such a signal, it will additionally be necessary to condition it, to the effect that a characteristic related to control engineering is taken into account when outputting the fault response signal, which requires a certain numerical calculation investment. The fault response signal may be a signal to close a tank or to deactivate an engine, so that the use of high-capacity computer components makes it possible to output the appropriate correct fault response signal very quickly. In contrast, if a computer component is used that has only an average working capacity, then the fault response signal could not be provided at the speed required for some applications.

According to example embodiments of the present invention, the second and third sensor monitoring modules may jointly be accommodated in the first or in the second data processing unit. This offers the advantage that the third sensor monitoring module always executes in the same data processing module and thus is able to carry out direct monitoring of the second sensor monitoring module as well, thereby ensuring that the second sensor monitoring module offers high operating reliability. In particular, it can be ensured in this manner that the second monitoring module is always correctly monitored by the third monitoring module, even if a distributed monitoring module architecture is provided.

In example embodiments of the present invention, the second and the third sensor monitoring modules are disposed inside the second data processing unit. This offers the advantage that the second and third sensor monitoring modules are always implemented on the computer component with the higher working capacity, so that efficient and rapid monitoring of the sensor is ensured.

Furthermore, there are arrangements in which the second data processing unit is coupled to the first data processing unit via a single data line. This offers the advantage that a fault request that is output by, for example, the first or second sensor monitoring module in a faulty operation of the sensor, is transmitted to the second data processing unit not via the bus line, but is able to be transmitted via the preferably direct, single data line. This provides a transmission possibility that is considerably faster since a time offset due to the encoding of a fault request signal for the bus transmission and for an assignment of a suitable time slot or time window for the bus transmission may be omitted.

In example embodiments of the present invention, the second data processing unit may be coupled to the sensor with the aid of a signal bus. This is advantageous inasmuch as the second data processing unit is able to read out the state of the sensor directly (via the signal bus), so that no time delay is to be expected in the transmission of the readout data.

For example, the second data processing unit may also be designed to output the fault response signal in response to a faulty operation of the sensor detected by the second sensor monitoring module. This has the advantage that the output fault response signal is based on a faulty operation of the sensor detected by the second sensor monitoring module. Once the function of the second sensor monitoring module is ensured by the monitoring with the aid of the third sensor monitoring module, a highly reliable fault response signal is able to be output according to this arrangement.

The third sensor monitoring module, as well, may be arranged to monitor the hardware or to monitor a program execution of a program of the data processing unit inside which the second sensor monitoring module is disposed. This provides an especially advantageous possibility for realizing the correct functioning of the second sensor monitoring module with very little effort and/or a low degree of complexity, i.e., on a low level from a standpoint of circuitry and program technology, so that possibly occurring faults are able to be detected in a reliable manner.

According to example embodiments of the present invention, a method for monitoring a sensor is provided, which is coupled to a first data processing unit, the method including the following steps: monitoring an operation of the sensor with regard to faults, using the first data processing unit, redundant monitoring of the operation of the sensor with regard to faults, monitoring the execution of the step of the redundant monitoring for faults, and outputting a fault response signal by a second data processing unit if a faulty operation of the sensor is detected.

In example embodiments of the present invention, the second data processing unit once again has higher capacity than the first data processing unit. Furthermore, it is preferred that the sensor is coupled to the first data processing unit via a signal bus.

It is also possible to provide a computer program to execute the aforementioned method when the computer program is running on a data processing system. This makes it possible to implement example embodiments of the present invention not only as a system or device, but to provide implementations in terms of process engineering.

Further features and aspects of example embodiments of the present invention are described in more detail below with reference to the appended Figures.

### BRIEF DESCRIPTION OF THE DRAWINGS

FIGS. 1 to 4 illustrate block diagrams of an exemplary embodiment of the present invention.

FIG. 5 is a flow chart of an exemplary embodiment of the present invention as a method.

### DETAILED DESCRIPTION

Identical or similar elements may have the same or similar reference numerals in the following figures. Furthermore, the figures of the drawing and their description include numerous features in combination. It should be appreciated that these features may also be evaluated singly or that they may be combined into additional combinations that are not explicitly described herein.

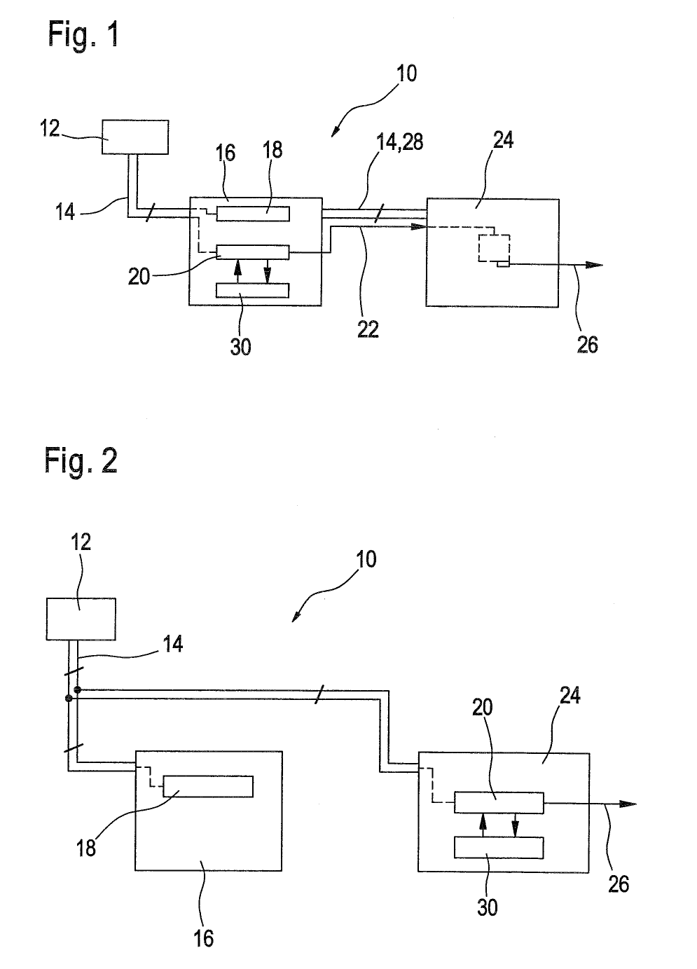

FIG. 1 shows a block diagram of an exemplary embodiment of the present invention. FIG. 1 shows a monitoring device 10 including a sensor 12, which is coupled with or connected to a first data processing unit 16 via a signal bus 14. Disposed in first data processing unit 16 is a first sensor monitoring module 18, which monitors an operation of sensor 12 with regard to the absence of faults. A level-1 module of a conventional sensor monitoring system corresponds to this first sensor monitoring module 18.

Furthermore, a second sensor monitoring module 20 is disposed in first data processing unit 16, which corresponds to a level-2 module of the conventional sensor monitoring system. This second sensor monitoring module 20 also may access data of sensor 12, which are transmitted to first data processing unit 16 via signal bus 14. At the same time, second sensor monitoring module 20 also monitors sensor 12 with regard to fault-free operation and when a fault case has been detected in sensor 12, it is able to transmit a corresponding fault request to a second data processing unit 24 via a fault request signal 22.

Second data processing unit 24 corresponds to a computing element that has a higher numerical working capacity than first data processing unit 16. For example, second data processing unit 24 is a central on-board computer of a motor vehicle if monitoring device 10 is to be used for monitoring sensors of a motor vehicle (as in the case of sensor 12). In this second data processing unit 24, fault request signal 22 is then converted into a corresponding fault response signal 26, which is able to be output. In this context, suitable control characteristics, for example, whose consideration requires higher numerical effort, can be taken into account here as well.

It is also possible for second data processing unit 24 to be coupled with or connected to first data processing unit 16 via the same signal data bus 14 or via a second signal bus 28 in order to ensure a data transmission via a central data bus. However, in order to ensure the fastest possible response in a detected fault case in sensor 12, it makes sense to route fault request signal 22 not via signal bus 14 but via separate fault request signal line 22, so that a high transmission rate is possible due to the fact that a bus encoding for the corresponding signal is able to be dispensed with.

To provide a robust operation and reliable fault signal requesting, in the exemplary embodiment of the present invention shown in FIG. 1 the operation of second sensor monitoring module 20 is monitored by a third sensor monitoring module 30. This third sensor monitoring module 30 is substantially able to ensure monitoring of the correct functioning of first data processing unit 16, advantageously on a lower level in terms of circuit engineering, such as a hardware test, a cyclical RAM/ROM test, an instruction sequence control, or an instruction set test. This ensures that second sensor monitoring module 20 implemented in first data processing unit 16 is in all likelihood operating correctly. In this context third sensor monitoring module 30 ensures that fault request signal 22 supplied by second sensor monitoring module 20 will be output correctly with the required high reliability in a detected faulty operation of sensor 12.

FIG. 2 shows an exemplary embodiment of the present invention in the form of a block diagram. However, in contrast to the exemplary embodiment shown in FIG. 1, second and third sensor monitoring modules 20 and 30 are not disposed inside first data processing unit 16, but in second data processing unit 24. Here, too, second sensor monitoring module 20 receives the relevant sensor data from sensor 12 via signal bus 14, which now is also routed directly to second data processing unit 24. Such a placement of second and third sensor monitoring modules 20 and 30, respectively, has the advantage that a first data processing unit 16 may be used that does not have the same high working capacity as first data processing unit 16 in the first exemplary embodiment. Instead, the high performance of second data processing unit 24 may also be used to realize redundant second sensor monitoring module 20 as well as third sensor monitoring module 30, which, from the standpoint of hardware, results in a simple implementation possibility because of the usually already provided numerical reserve in second data processing unit 24.

The level-2 monitoring module for networked sensors can be accommodated in any control device that is coupled with or connected to the corresponding sensors, for instance via a communications bus. In FIGS. 1 and 2, for example, second sensor monitoring module 20 may be integrated either into first data processing unit 16 (e.g., an ECU_A; ECU=engine control unit), or into second data processing unit 24 (e.g., an ECU_B). However, this requires the use of bus-enabled sensors, such as hydrogen concentration sensors having CAN interfaces, or angular position sensors having SPI interfaces in motor vehicles.

The fault response signals that are initiated by second sensor monitoring modules 20 in the two exemplary embodiments, may be implemented directly by the control device or second data processing unit 24, inside which second sensor monitoring module 20 is located. In FIG. 1, the fault request may be executed by second sensor monitoring module 20 in first data processing unit 16 (e.g., ECU_A), whereas this fault request, in the form of a fault response signal, is implemented in second data processing unit 24 (e.g., ECU_B) according to the exemplary embodiment shown in FIG. 2.

However, the fault responses may also be forwarded to other control devices via a bus, where the fault responses are then executed. In FIG. 1, second sensor monitoring module 20 in first data processing unit 16 is able to transmit the request for the fault response via second signal bus 28 to second data processing unit 24, in which the desired fault response is executed.

The fault requests are also to be able to be forwarded via discrete lines. In FIG. 1, the fault response request is transmittable in the form of a discrete signal via line 22 from first data processing unit 16 to second data processing unit 24. For example, a HIGH level on discrete line 22 may indicate normal operation, whereas a LOW level indicates a faulty state of sensor 12. Alternatively, a PWM signal having fixed frequencies may also indicate a normal state of the sensor, whereas a level signal (i.e., frequency=0 Hz) indicates a faulty state of the sensor.

The receiving control device, in this case, second data processing unit 24, evaluates the state on discrete line 22 and executes the fault response accordingly. Associated third sensor monitoring modules 30 for corresponding second sensor monitoring modules 20 are to be executed on the same control device as associated second sensor monitoring modules 20, which they are to monitor. Among the functions of third sensor monitoring modules 30 are, for example (but not exclusively), cyclical RAM/ROM tests, program flow control and/or command set tests.

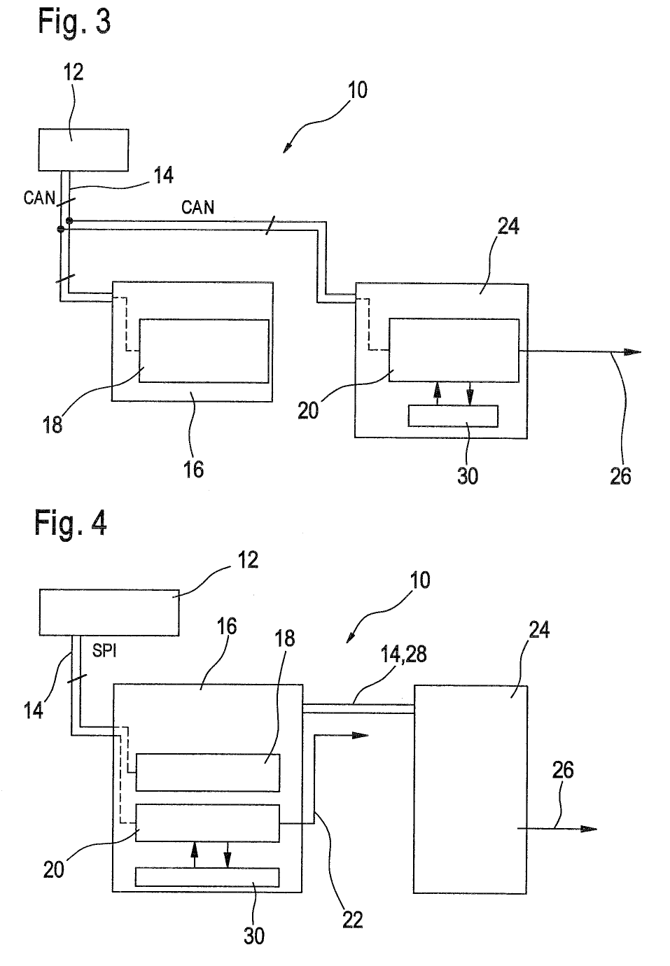

FIG. 3 represents a circuit diagram of an exemplary embodiment of the present invention in a fuel cell vehicle. The layout of the monitoring device corresponds to the layout shown in FIG. 2. An H₂ concentration sensor 12 forwards the instantaneous H₂ concentration to the two control devices 16 and 24 via CAN bus 14. First control device 16 (a tank control unit, for example) reads in the H₂ concentration and controls the tank valves. However, second sensor monitoring module 20, such as a redundant H₂ concentration monitor, for example, does not run in the first control device, i.e., tank control unit 16, but in second control device 24, i.e., the vehicle control unit. In the event of a fault, second sensor monitoring module 20 is able to deactivate the tank valves or even the primary relay.

In FIG. 4, a circuit diagram of an exemplary embodiment of the present invention is shown, which has a similar layout as that in FIG. 1. In this context, an exemplary configuration in an electric vehicle is shown. A vehicle control unit 16 monitors a linear acceleration of the vehicle by reading in an acceleration signal output by an acceleration sensor, via an SPI bus 14. If the acceleration is excessive or greater than a value desired by the driver and/or other systems (such as ESP), then a request for deactivation of an electromotor of the vehicle is transmitted to an electrometer control unit 24 via a discrete line 22, for instance by triggering a change in level from HIGH to LOW. HIGH means without fault, for example, and LOW means that the electromotor should be switched off. Electromotor control unit 24 responds to the request and deactivates the electrometer immediately via fault response signal 26 (possibly taking potential control characteristics for the corresponding motor into account).

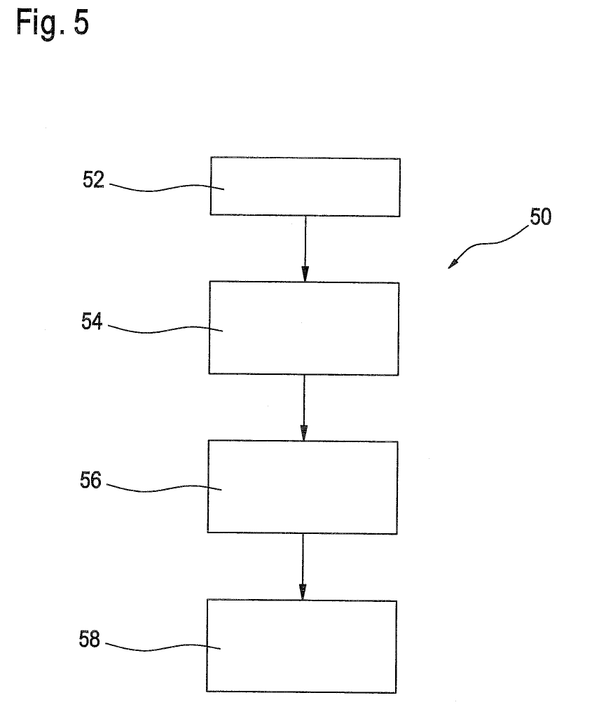

FIG. 5 shows a flow chart of an exemplary embodiment of the present invention as method 50. In this context, in a first step 52, an operation of sensor 12 is monitored for faults by first data processing unit 16. Parallel therewith or, as shown in FIG. 5, subsequently, redundant monitoring of the operation of sensor 12 for faults takes place in a second step 54. The fault-free execution of the second step, i.e., the redundant monitoring step, is monitored in a third step 56. Finally, in a fourth step 58, a fault response signal 26 is output by a second data processing unit 24, which preferably has a greater working capacity than first data processing unit 16 and which is coupled or connected thereto if a faulty operation of the sensor is detected.

The afore-described arrangements provide approaches that provide distributed component monitoring and function monitoring in systems having networked sensors. In addition, it should be possible to transmit fault response requests to other control devices not via a signal bus but via discrete lines.

An advantage of example embodiments of the present invention is that the monitoring modules, in particular the second and third sensor monitoring modules, may be situated in any control device that is coupled to the monitored sensors via the signal bus. For example, specific monitoring may be executed in a control device having spare capacity in terms of computing capacity. Another advantage is that the request for fault responses is able to be forwarded more rapidly via discrete lines. Specifically in the case of electric vehicles where very short fault response times are required, this approach is highly advantageous.

What is claimed is:

1. A monitoring device for a sensor of a motor vehicle, comprising:
a first sensor monitoring module adapted to monitor an operation of the sensor for faults;
a second sensor monitoring module adapted to monitor the operation of the sensor for faults;
a third sensor monitoring module adapted to monitor an operation of the second sensor monitoring module;
a first data processing unit that includes the first sensor monitoring module and is couplable to the sensor; and
a second data processing unit coupled to the first data processing unit;
wherein the second data processing unit is adapted to output a fault response signal when a faulty operation of the sensor is detected.

2. The monitoring device according to claim 1, wherein the motor vehicle is arranged as a fuel cell motor vehicle.

3. The monitoring device according to claim 1, wherein the second and the third sensor monitoring modules are at least one of (a) jointly arranged the first data processing unit and (b) jointly arranged in the second data processing unit.

4. The monitoring device according to claim 1, wherein at least one of (a) the first and (b) the second data processing unit is coupled to the sensor via a signal bus.

5. The monitoring device according to claim 1, wherein the second data processing unit is coupled to the first data processing unit via a single data line separate from a signal bus.

6. The monitoring device according to claim 1, wherein the second data processing unit has greater working capacity than the first data processing unit.

7. The monitoring device according to claim 1, wherein the second data processing unit is arranged as an onboard computer of the motor vehicle.

8. The monitoring device according to claim 1, wherein the second data processing unit is adapted to output the fault response signal in response to a faulty operation of the sensor detected by the second sensor monitoring module.

9. The monitoring device according to claim 1, wherein the third sensor monitoring module is adapted to implement at least one of (a) monitoring of hardware and (b) monitoring of a program flow of a program of the data processing unit in which the second sensor monitoring module is arranged.

10. A sensor, comprising:
a monitor device including:
a first sensor monitoring module adapted to monitor an operation of the sensor for faults;
a second sensor monitoring module adapted to monitor the operation of the sensor for faults;
a third sensor monitoring module adapted to monitor an operation of the second sensor monitoring module;
a first data processing unit that includes the first sensor monitoring module and is couplable to the sensor; and
a second data processing unit coupled to the first data processing unit;
wherein the second data processing unit is adapted to output a fault response signal when a faulty operation of the sensor is detected.

11. The sensor according to claim 10, wherein the sensor is arranged as a motor vehicle sensor.

12. A method for monitoring a sensor coupled to a first data processing unit, comprising:
monitoring an operation of the sensor for faults by the first data processing unit;
redundant monitoring of the operation of the sensor for faults;
monitoring the redundant monitoring for faults; and
outputting a fault response signal by a second data processing unit if a faulty operation of the sensor is detected.

13. The method according to claim 12, wherein the second data processing unit has a greater working capacity than the first data processing unit.

14. The method according to claim 12, wherein the sensor is coupled to the first data processing unit via a signal bus.
